(19) United States
(12) Patent Application Publication
(10) Pub. No.: US 2010/0207349 A1
(43) Pub. Date: Aug. 19, 2010

(54) SCOOTER WITH AUXILIARY ASSEMBLY

(76) Inventors: Po-Lin Chiu, Kaohsiung City (TW); Sherng-Ji Tsay, Kaohsiung City (TW); Ching-Piao Chang, Fong Shan City (TW)

Correspondence Address: Dr. BANGER SHIA;Patent Office of Bang Shia, 102 Lindencrest Ct, Sugar Land, TX, 77479-5201, US

(21) Appl. No.: 12/683,320

(22) Filed: Jan. 6, 2010

(30) Foreign Application Priority Data
Feb. 19, 2009 (TW) 098202377

(51) Int. Cl. B62M 1/04

(52) U.S. Cl. 280/221

(57) ABSTRACT

A scooter with auxiliary assembly comprises a frame, a steering rod pivoted on the frame, a front wheel pivoted on the steering rod, a drive assembly fixed on the frame, and rear wheels pivoted on the frame and driven by the drive assembly. At least one pedal is pivoted on the frame, an elastic body connected the pedal and the frame, and at least one transmission assembly actuated by the pedal to rotate the rear wheels; wherein, the scooter has an auxiliary assembly that includes at least one supporter extended from the frame and at least one auxiliary wheel pivotally coupled to the supporter; the auxiliary wheel gets away from the ground due to the rear wheels while laying the scooter on the ground and properly contacts with the ground when the scooter is slant aside in time of forwarding.

### BACKGROUND OF THE INVENTION

1. Field of the Invention

The present invention relates to a scooter, in particular to a scooter with auxiliary assembly, which provides users with a steady marching balance during the operation and concurrently achieves an exercise purpose.

2. Description of the Related Art

Referring to FIG. 1 shows a conventional scooter 1 comprising a frame 11, a steering rod 12 pivoted on the frame 11, a front wheel 13 pivotally coupled to the steering rod 12, a drive assembly 14 disposed on the frame 11, and two rear wheels 15 pivotally disposed on the frame 11 and driven by the drive assembly 14. Wherein, two handlebars 121 are formed on the steering rod 12 for controlling the advance direction of the front wheel 13. Further, the drive assembly 14 comprises one pedal 141 disposed on the frame 11 pivotally, one elastic body 142 coupled to the pedal 141, and a transmission assembly 143 actuated by the pedal 141 to rotate the rear wheels 15. Whereby, when the pedal 141 is trodden, the elastic body 142 provides a rebound power to spring the pedal 141 back to its original position and drive the two rear wheels 15 rotated. Further referring to FIG. 2, the transmission assembly 143 comprises a curved rack 1431 connected to the pedal 141, sprocket wheels 1432 engaged with the curved rack 1431, and a bearing 1433 pivotally disposed between the sprocket wheels 1432.

Referring to FIG. 1, running up to move the scooter 1 forwards, users then step on the pedal 141 repeatedly to actuate the transmission assembly 143 and rotate the rear wheels 15 via a reciprocal rebound power provided by the elastic body 142. Herein, the steering rod 12 is further applied to facilitate the operating stability of the frame 11, so that the scooter 1 could be preferably moved forwards.

However, since users need to step on the pedals 141 repeatedly for the scooter 1 to move forwards, the steering rod 12 has to be firmly gripped so that the driving balance could be achieved. In addition, users also have to keep their balance while standing on the frame 11 and synchronically move one of their feet to propel the pedal 141. As a result, users' fulcrum would lean toward the rear part of the frame 11, thence resulting in an unexpected springing of the frame 11 and rendering the scooter 1 slanted, thereby incurring a potential risk of using.

### SUMMARY OF THE INVENTION

The object of the present invention is to provide a scooter with auxiliary assembly for sustaining a slanted scooter that is out of balance during the operation to increase its using safety.

The scooter with auxiliary assembly in accordance with the present invention comprises a frame, a steering rod pivoted on the frame, a front wheel pivoted on the steering rod, a drive assembly fixed on the frame, and two rear wheels pivoted on the frame and driven by the drive assembly. Wherein, the scooter further comprises an auxiliary assembly that would not contact the ground unless the scooter slants over a certain angle during the operation, thereby increasing the using safety.

An object of the instant invention is to provide a scooter with auxiliary assembly comprising a frame, a steering rod pivoted on the frame, a front wheel pivoted on the steering rod, a drive assembly fixed on the frame, and two rear wheels pivoted on the frame and driven by the drive assembly; wherein, two handlebars being formed on the steering rod for controlling a marching direction of the front wheel; the drive assembly further includes at least one pedal pivoted on the frame, an elastic body disposed between the pedal and the frame, and at least one transmission assembly actuated by the pedal to rotate the rear wheels. Wherein, the scooter further includes an auxiliary assembly that has at least one supporter extended from the frame and at least one auxiliary wheel pivotally coupled to the supporter. The auxiliary wheel departs from the ground via a support of the rear wheels while laying the scooter on the ground and contacts with the ground while slanting the scooter about the ground.

Preferably, two transmission assemblies are separately disposed the frame for respectively driving rotations of the rear wheels.

Preferably, the handlebar further includes a brake set providing with a brake handle installed on the handlebar, a brake sheet disposed on the rear wheels, and a brake line connecting the brake handle with the brake sheet.

The advantages of the present invention over the known prior arts will become more apparent to those of ordinary skilled in the art upon reading the following descriptions in junction with the accompanying drawings.

### BRIEF DESCRIPTION OF THE DRAWINGS

The advantages of the present invention over the known prior art will become more apparent to those of ordinary skilled in the art upon reading the following descriptions in junction with the accompanying drawings.

FIG. 1 is a perspective view showing a conventional scooter;

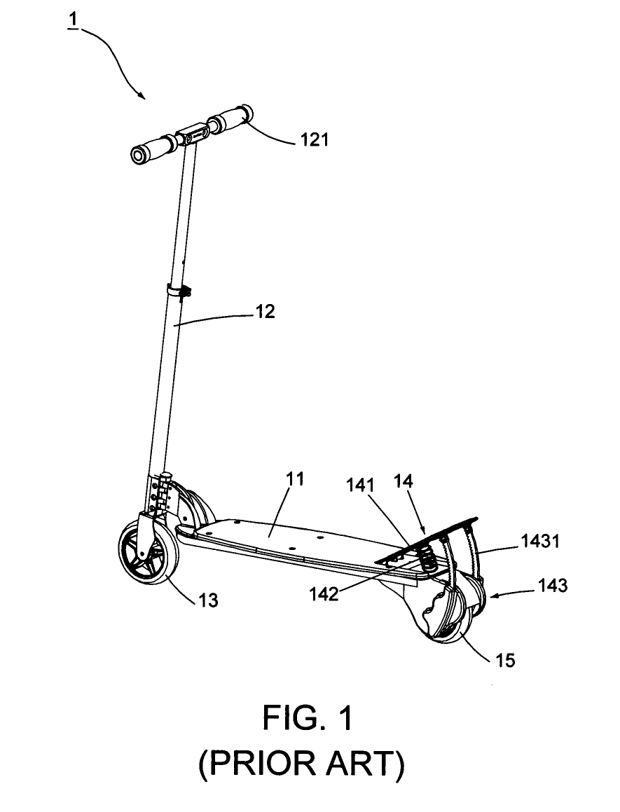

FIG. 2 is a perspective view showing the partial conventional scooter;

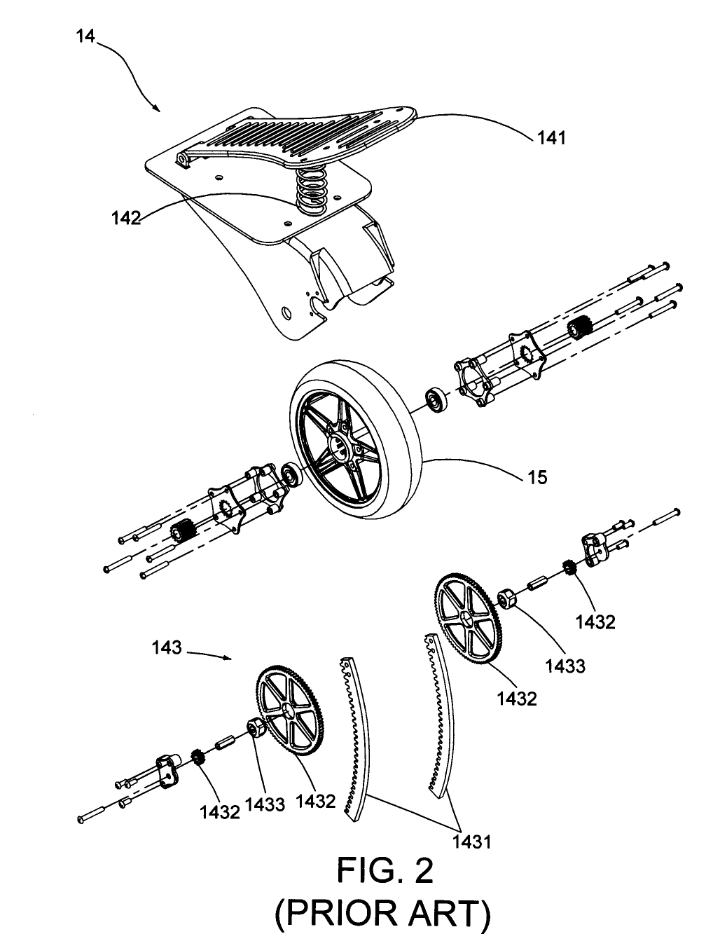

FIG. 3 is a perspective view showing a first preferred embodiment of the present invention;

FIG. 4 is a perspective view showing the partial first preferred embodiment of the present invention; and

FIG. 5 is a perspective view showing a second preferred embodiment of the present invention.

### DETAILED DESCRIPTION OF THE PREFERRED EMBODIMENTS

Before the present invention is described in greater detail, it should be noted that the like elements are denoted by the same reference numerals throughout the disclosure.

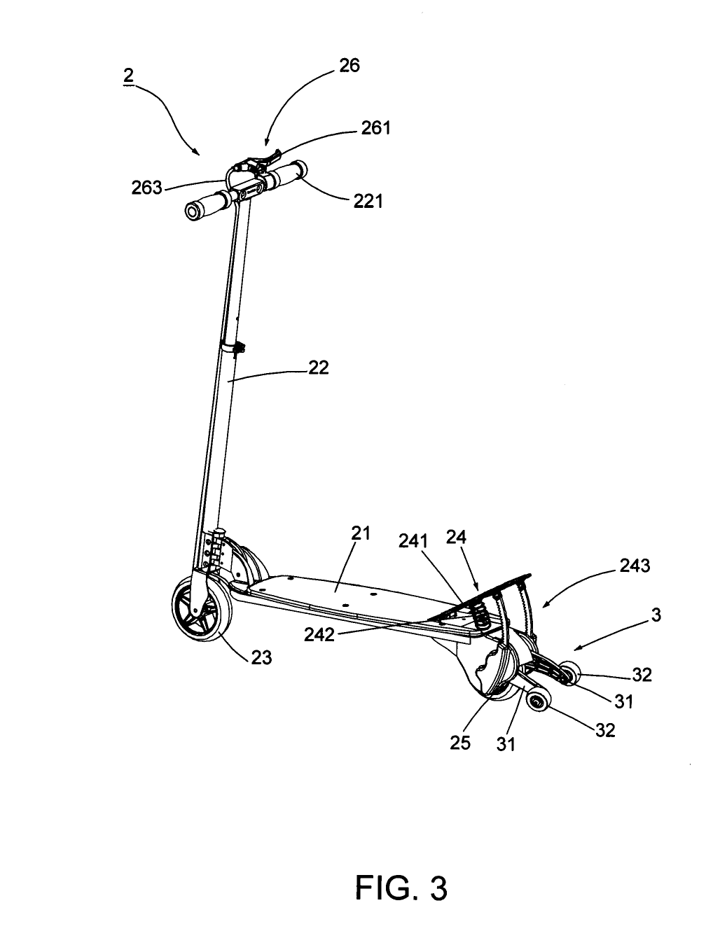

Referring to FIG. 3, a scooter 2 with auxiliary assembly of a first preferred embodiment of the present invention comprises a frame 21, a steering rod 22 pivoted on the frame 21, a front wheel 23 pivoted on the steering rod 22, a drive assembly 24 fixed on the frame 21, and two rear wheels 25 pivoted on the frame 21 and driven by the drive assembly 24. Wherein, the same formation, application, and efficiency of aforesaid assemblage as those of the conventional scooter are herein omitted. Especially, the scooter 2 further comprises an auxiliary assembly 3 coupled to the frame 21. Wherein, the auxiliary assembly 3 includes at least one supporter 31 extended from the frame 21 and at least one auxiliary wheel 32 pivoted on the supporter 31. Substantially, the number of the supporter 31 could be alternatively adjusted according to the practical application, and two supporters 31 in the embodiment are adopted. Moreover, each supporter 31 respectively provides with an auxiliary wheel 32. Accordingly, the auxiliary wheels 32 would not contact the ground when the scooter 2 straight stands on the ground.

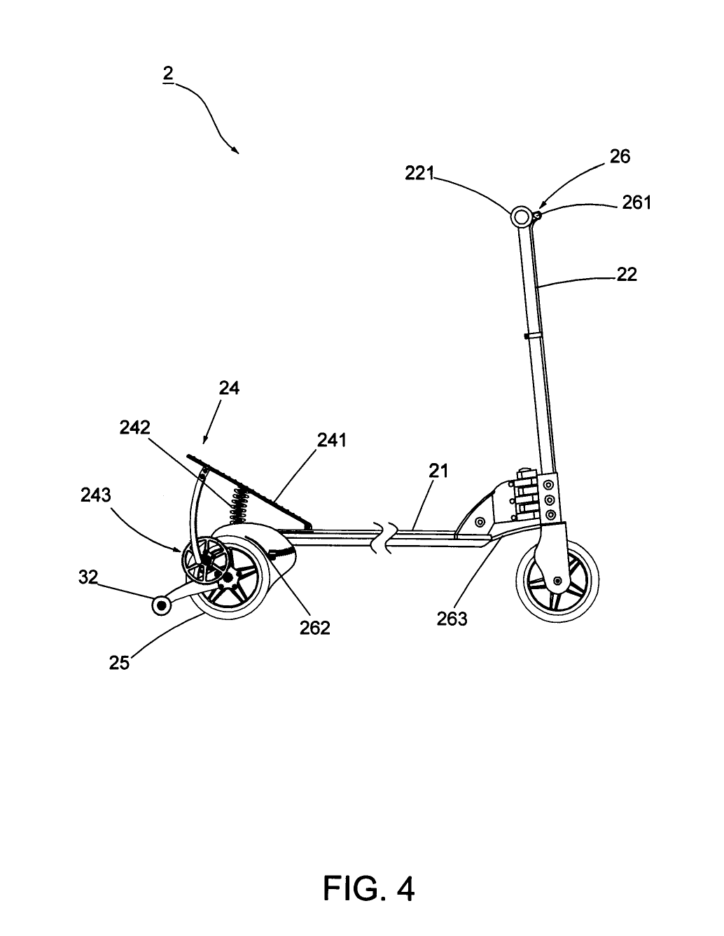

Referring to FIG. 4, the present invention could be also facilely decelerated or completely stopped due to a brake set 26 further installed on the handlebar 221 of the steering rod 22. Wherein, the brake set 26 provides with a brake handle 261 installed on the handlebar 221, a brake sheet 262 disposed on the rear wheels 25, and a brake line 263 connecting the brake handle 261 with the brake sheet 262. Thereby, the move speed of the rear wheels 25 could be controlled.

Referring to FIGS. 3 and 4, in operation, users hold the steering rod 22 to control the moving direction of the scooter 2. Subsequently, users stand on the frame 21 by one foot and repeatedly prop against the ground by the other foot for forwarding the scooter 2. Afterwards, users step on the pedal 241 repeatedly for further cooperating with the rebound power provided by the elastic body 242 to actuate the transmission assembly 243 and rotate the rear wheels 25. Thereby, the scooter 2 moves forwards. Wherein, if the scooter 2 inadvertently slants aside in view of the improper execution of the strength during the operation, the auxiliary wheels 32 would timely prop against the ground. That is to say, the auxiliary wheel 32 could properly assist users in keeping their balance on the scooter 2 in time of marching so as to avoid a wavering sliding and decrease the occurrence of risky manipulations. As a result, the scooter 2 would possess a favorable using safety.

Furthermore, the scooter 2 may generate a speedy marching while incessantly treading the pedal 241. Moreover, the scooter 2 in such a speedy marching condition would also need an emergent deceleration or stop due to unexpected circumstances. In such situations, users merely need to clutch the brake handle 261 on the handle bar 221 to trigger the brake line 263 and thence set off the brake sheet 262, so as to retard the rotation of the rear wheels 25 and slow down the speed of the scooter 2, hence effectively preventing possible dangers.

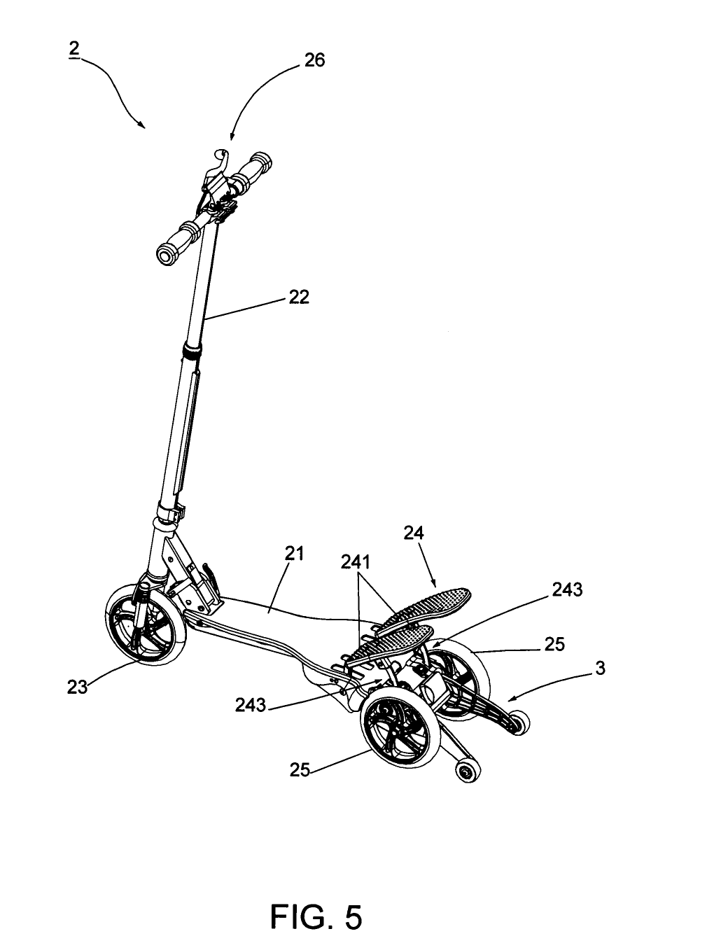

Referring to FIG. 5 shows a second preferred embodiment of the present invention comprising a frame 21, a steering rod 22, a front wheel 23, a drive assembly 24, rear wheels 25, a brake set 26, and an auxiliary assembly 3 similar to those of the first preferred embodiment. Wherein, the drive assembly 24 includes two transmission assemblies 243 separately installed on the frame 21. Thereby, each transmission assembly 243 would respectively rotate the rear wheels 25. In use, users could tread their feet on the pedals 241 of the drive assembly 24 for preferably speeding up the scooter 2

To sum up, the present invention takes advantage of the auxiliary assembly propping against the ground to stabilize the equilibrium of the scooter while the scooter slantingly moves forwards. Accordingly, the present invention attains a preferable using safety of the scooter.

While we have shown and described the embodiment in accordance with the present invention, it should be clear to those skilled in the art that further embodiments may be made without departing from the scope of the present invention.

I claim:

1. A scooter with auxiliary assembly comprising a frame, a steering rod pivoted on said frame, a front wheel pivoted on said steering rod, a drive assembly fixed on said frame, and two rear wheels pivoted on said frame and driven by said drive assembly; wherein, two handlebars being formed on said steering rod for controlling a marching direction of said front wheel; said drive assembly further includes at least one pedal pivoted on said frame, an elastic body disposed between said pedal and said frame, and at least one transmission assembly actuated by said pedal to rotate said rear wheels;
wherein, said scooter further comprising an auxiliary assembly that includes at least one supporter extended from said frame and at least one auxiliary wheel pivotally coupled to said supporter; said auxiliary wheel departing from the ground via a support of said rear wheels while laying said scooter on the ground and contacting with the ground while slanting said scooter about the ground.

2. The scooter as claimed in claim 1, wherein two transmission assemblies are separately disposed said frame for respectively driving rotations of said rear wheels.

3. The scooter as claimed in claim 1, wherein, said handlebar further includes a brake set providing with a brake handle installed on said handlebar, a brake sheet disposed on said rear wheels, and a brake line connecting said brake handle with said brake sheet.
